(19) United States
(12) Patent Application Publication
(10) Pub. No.: US 2026/0008492 A1
(43) Pub. Date: Jan. 8, 2026

(54) VEHICLE CORNER MODULE AND VEHICLE

(71) Applicant: Continental Automotive Technologies GmbH, Hannover (DE)

(72) Inventors: Alexandru Mihalache, Iasi (RO); Alexandru Paval, Iasi (RO); Daniel Ratus, Iasi (RO); Ionut-Sergiu Istrati, Iasi (RO)

(73) Assignee: Continental Automotive Technologies GmbH, Hannover (DE)

(21) Appl. No.: 19/260,326

(22) Filed: Jul. 4, 2025

(30) Foreign Application Priority Data
Jul. 5, 2024 (EP) 24465545.2

(51) Int. Cl. B62D 5/04; B60G 3/20; B60G 11/27; B62D 7/10

(52) U.S. Cl. CPC B62D 5/0418; B60G 3/20; B60G 11/27; B62D 5/0403; B62D 5/046; B62D 5/0484; B62D 5/0487; B62D 7/10; B60G 2200/144; B60G 2202/152; B60G 2204/416

(57) ABSTRACT

A vehicle corner module for wheel-individual steering comprises a wheel portion, a vehicle portion and a steering mechanism. The steering mechanism comprises a steering motor and a gearbox. The steering motor is configured to rotate the wheel portion about a steering axis relative to the vehicle portion by way of the gearbox. The reliability and service life of such a vehicle corner module is to be increased. For this purpose, it is provided that the steering mechanism comprises two steering motors, each of which is configured to rotate the wheel portion about the steering axis relative to the vehicle portion by way of the common gearbox. Furthermore provided is a vehicle comprising at least one, preferably two or four, such vehicle corner modules.

### TECHNICAL FIELD

The embodiments relate to a vehicle corner module for individual wheel steering, and furthermore relate to a vehicle comprising at least one such vehicle corner module.

### BACKGROUND

A vehicle corner module of this type is known, for example, from KR 20240016627 A. The vehicle corner module there is in each case connected on an upper side to the body at the steering mechanism as well as at a shock suspension device.

CN 115447665 B shows a vehicle corner module having two steering motors which are disposed perpendicularly to the steering axis.

Other steering assemblies having two steering motors for ordinary motor vehicles (without wheel-individual control) are known from CN 218750980 U and CN 116279762 A.

Wheel-integrated motors have so far been widely used, for example, in electric scooters or aircraft wheels, as they have a high efficiency and permit a space-saving construction mode. For cars or other road vehicles, wheel hub motors of this type with integrated friction brakes, however, fundamentally also permit a significant redesign of the vehicle body and new control and steering concepts with large steering angles, which would hardly be possible in a space-efficient manner with a central motor for driving two wheels or four wheels. This is referred to, inter alia, as vehicle corner modules or eCorner modules. However, it is still desirable to improve reliability, as these are typically steer-by-wire systems. It is also useful to reduce the space consumption of the vehicle corner modules and at the same time provide adequate steering functionality for new control concepts.

### SUMMARY

Accordingly, a vehicle corner module is characterized in that the steering mechanism comprises two steering motors, each of which is configured to rotate the wheel portion about the steering axis relative to the vehicle portion by way of the common gearbox.

This design embodiment permits a reliability and at the same time permits the steering output to be flexibly adapted when providing wheel-individual steering. At the same time, the service life of the vehicle corner module and the maintenance intervals can be extended. In this instance, failure of one of the steering motors does not result in the loss of the steering capability of the connected vehicle wheel. In contrast to conventional steering arrangements, the voluminous assembly consisting of the axle steering link with fasteners and lever assemblies can be dispensed with.

The vehicle portion can, for example by means of connection geometries, be configured to be connectable to a body or a chassis of the vehicle and does not per se have to comprise substantial parts of the vehicle. For example, instead of being connected to the body, it is possible for the vehicle corner module to be used in a “rolling chassis” concept, or for the corner modules to be connectable directly to a chassis.

The motor axes of the steering motors may be disposed so as to be offset parallel to the steering axis. Despite the redundant steering motors, a compact design and a simple link to the common gearbox can be achieved as a result. The motor axes of the steering motors may be disposed in parallel on opposite sides of the steering axis. As a result, mounting and force flux may have a high degree of symmetry.

The gearbox and the steering motors may be configured in such a way that, in a normal operating mode, only ever one of the steering motors actively rotates the wheel portion about the steering axis relative to the vehicle portion by way of the common gearbox. This increases the service life of the steering motors and thus of the vehicle corner module.

In one embodiment, the gearbox and the steering motors are, in a cooperation mode, configured to simultaneously rotate the wheel portion about the steering axis relative to the vehicle portion by way of the common gearbox. The steering motors can then provide a steering torque simultaneously by way of the same gearbox if this is desired or required, for example, for reasons pertaining to driving situations, weather or ground conditions.

The vehicle corner module may comprise a control unit which is configured to detect a failure of one of the steering motors, and in this case to carry out a steering actuation completely by way of the steering motor that has not failed.

The gearbox may comprise a planetary gearbox which is disposed for example so as to be coaxial with the steering axis. This design embodiment enables a compact design of the steering mechanism and an uncomplicated connection of two steering motors to the same gearbox.

The wheel portion may comprise an axle stub which has torque transmission elements in which the gearbox engages in order to transfer a steering torque to the wheel portion during operation. The axle stub may be simultaneously designed to be connected to a wheel-integrated friction brake, for example to a brake caliper of a disk brake.

The wheel portion may comprise a wheel-integrated electric motor and/or a wheel-integrated friction brake.

In an embodiment, the axle stub at an upper end comprises a steering base on which the steering mechanism sits and on which the torque transmission elements are disposed. A construction of this type permits the vehicle to be supported in a stable manner by way of the steering base, and the output torque of the steering mechanism to be simultaneously adapted by way of the sizing of the transmission and the spacing of the torque transmission elements from the steering axis.

Disposed between the wheel portion and the vehicle portion is an electromagnetic coupling which is configured to fix in a coupling mode the current relative rotation angle between the wheel portion and the vehicle portion. This makes it possible to fix the wheel portion and the vehicle portion relative to one another if the driving situation permits this, and to deactivate the steering motors in order to reduce wear and energy consumption. This can be the case temporarily, for example, if the steering angle changes only very slightly (e.g. when driving on the motorway).

Disposed between the wheel portion and the vehicle portion is an electromagnetic coupling which is configured to be operated in a steering brake mode in which the electromagnetic coupling counteracts a relative rotating movement between the wheel portion and the vehicle portion with a braking torque, wherein control of the braking torque of the electromagnetic coupling in the steering brake mode may be performed by means of pulse width modulation. In this way, the wheel portion and vehicle portion are not completely rigidly fixed, but any change in the steering angle is merely decelerated or dampened. As a result, the steering motors can also be deactivated to reduce wear and energy consumption. This can be the case temporarily, for example, if the steering angle changes only very slightly (e.g. when driving on the motorway). Adjusting the pulse width modulation then allows the braking torque provided by the electromagnetic coupling to be controlled.

The vehicle corner module may comprise a main support comprising at least one connection geometry which is configured for a horizontal connection of the vehicle corner module to a vehicle, wherein for example no connection geometry is provided for a vertical connection between the vehicle corner module and the vehicle. This permits a low installation height of the vehicle corner module, for example in comparison to KR 20240016627 A, in which the steering mechanism protrudes significantly beyond the wheel height.

At least one upper cross member may be pivotably fastened to an upper end of the steering mechanism and pivotably fastened to an upper end of the main support. This construction permits a compact integration of a shock suspension device into the vehicle corner module by fastening the wheel portion to the main support, so as to be pivotable twice and thus displaceable within limits on the latter, by way of the upper cross member.

In one embodiment at least one lower cross member is connected to the axle stub below the steering base by means of a ball joint, wherein the lower cross member is pivotably connected to the main support. This construction permits large maximum steering angles by virtue of the main support and the axle stub being connected by the lower cross member by means of a ball joint. Such a, or a similar, second connection between the wheel portion and the vehicle portion bypassing the steering mechanism is typically required for stability reasons. Furthermore, the lower cross member also permits a compact integration of a shock suspension device into the vehicle corner module.

Disposed between the main support and the lower cross member is a shock suspension device, in particular a gas or air spring, wherein the lower end of the shock suspension device is pivotably fastened to the lower cross member. For example, the shock suspension device can protrude beyond the lower cross member. As a result, a sufficiently long installation height of the shock suspension device can be achieved without the overall height of the vehicle corner module having to be increased upwards or downwards.

Each steering motor may be covered by its own steering motor cover which enables access to the individual steering motors for maintenance and replacement purposes, for example without requiring further elements of the vehicle corner module to be dismantled beyond the steering motor cover and the steering motor. The steering mechanism camayn then comprise a steering housing having in each case one steering motor cover as an individually removable access to each of the steering motors. Therefore, a steering motor can then be replaced without disassembling and reassembling the remainder of the wheel portion.

Moreover, a vehicle comprising at least one, likely four, vehicle corner modules according to one of the above embodiments for wheel-individual steering of a vehicle wheel connected to the vehicle corner module.

The vehicle may comprise a vehicle control unit which is configured to detect a high-demand mode and thereupon to instruct at least one vehicle corner module to activate the cooperation mode. The cooperation mode can however also be activated and deactivated in a targeted manner by a user. This permits a higher steering torque to be temporarily provided if necessary or desired.

The vehicle control unit is configured to detect the high-demand mode in one or a plurality of the following situations: poor road conditions, off-road situation, poor weather conditions, evasive maneuvers, parking maneuvers, turning maneuvers.

The vehicle control unit can then activate the cooperation mode in individual or all vehicle corner modules to temporarily provide a higher steering torque and improve the steering capability.

The vehicle may comprise a vehicle control unit which is in a steering stability mode configured to activate the coupling mode or the steering brake mode and to deactivate the steering motors in at least one vehicle corner module.

Further details are derived from the description of the illustrated exemplary embodiments and the appended claims.

### BRIEF DESCRIPTION OF THE DRAWINGS

In the figures:

FIG. 1 shows an embodiment of a vehicle corner module,

FIG. 2 shows a detailed view of a steering mechanism,

FIG. 3 shows the steering mechanism of FIG. 2 in an exploded illustration, and

FIGS. 4 to 6 show detailed views of a steering mechanism, having a connected axle stub at three different rotation angles.

### DETAILED DESCRIPTION

In the detailed description of the embodiments below, the same reference signs denote substantially the same or identical parts in or on these embodiments. However, for improved understanding the embodiments illustrated in the figures are not always illustrated to scale.

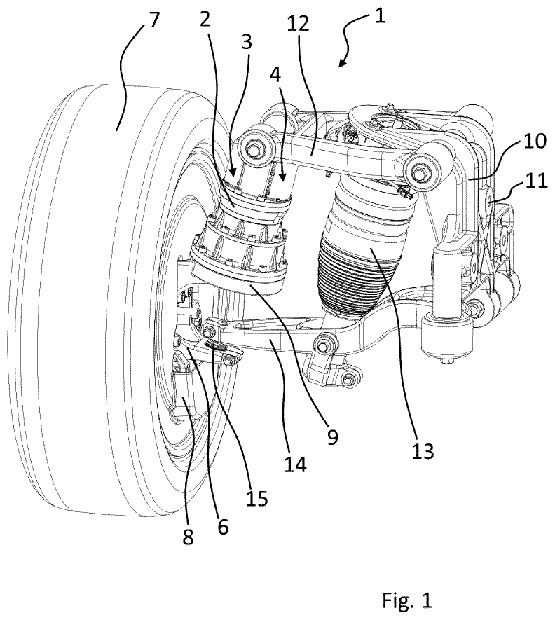

FIG. 1 shows a vehicle corner module 1, comprising a wheel portion, a vehicle portion and a steering mechanism 2. The steering mechanism 2 comprises two steering motors 3, 4, and a gearbox 5. The two steering motors 3, 4 are in each case configured to rotate the wheel portion about the steering axis relative to the vehicle portion by way of the common gearbox 5.

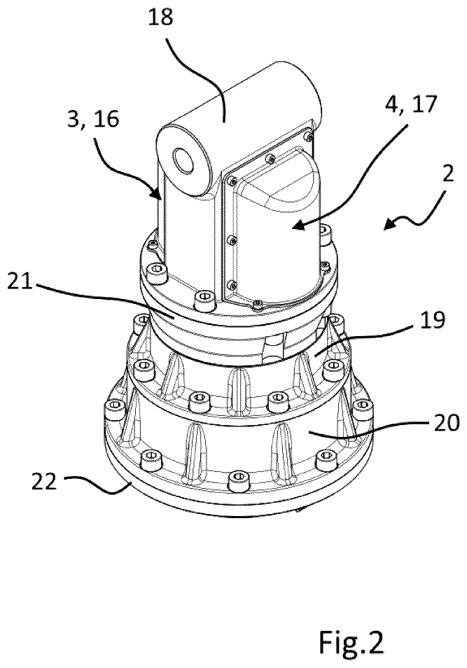

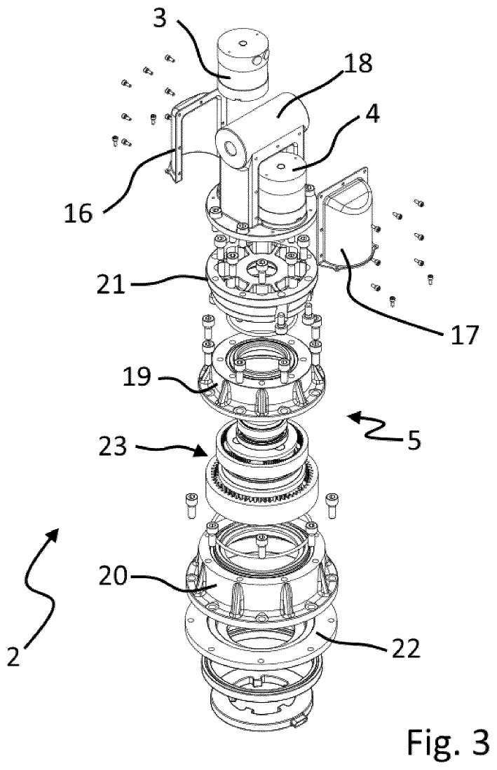

The motor axes of the steering motors 3, 4 are disposed so as to be offset parallel to the steering axis which extends centrally through the gearbox 5 (see also FIGS. 2 and 3).

The wheel portion comprises an axle stub 6 and a wheel 7 connected thereto. The axle stub 6 may be simultaneously designed to be connected to a wheel-integrated friction brake 8, for example to a brake caliper of a disk brake. The wheel portion can also include a wheel-integrated electric motor and/or a wheel-integrated friction brake 8.

The axle stub 6 at an upper end comprises a steering base 9 on which the steering mechanism 2 sits and on which torque transmission elements are disposed (not explicitly illustrated).

The vehicle corner module 1 comprises a main support 10, which comprises at least one connection geometry 11 (presently three), which is configured for a horizontal connection of the vehicle corner module 1 to a vehicle. However, no connection geometries are provided for a vertical connection between the vehicle corner module 1 and the vehicle. This permits a low installation height of the vehicle corner module.

An upper cross member 12 is pivotably fastened to an upper end of the steering mechanism 2 and pivotably fastened to an upper end of the main support 10. This construction permits for example a compact integration of a shock suspension device 13 into the vehicle corner module 1 by fastening the wheel portion to the main support 10, so as to be pivotable twice and thus displaceable within limits on the latter, by way of the upper cross member 12. The upper cross member 12 comprises two rods connected by a bridge near the steering mechanism 2. This frees up space between the rods for the upper end of the shock suspension device 13.

A lower cross member 14 is connected to the axle stub 6 below the steering base 9 by means of a ball joint 15. The lower cross member 14 is pivotably connected to the main support 10. This construction permits large maximum steering angles by virtue of the main support 10 and the axle stub 6 being connected by the lower cross member 14 by means of a ball joint 15.

The shock suspension device 13, for example as a gas or air spring, is disposed between the main support 10 and the lower cross beam 14. The lower end of the shock suspension device 13 is pivotably fastened to the lower cross member 14. The shock suspension device 13 protrudes downwards beyond the lower cross member 14. As a result, a sufficiently long installation height of the shock suspension device 13 can be achieved without the overall height of the vehicle corner module 1 having to be increased upwards or downwards.

For example, the wheel portion can comprise one or a plurality of the following components: the wheel 7, the axle stub 6, the friction brake 8, a wheel-integrated electric motor, the steering mechanism 2 (partially), the gearbox (partially).

Thus, the vehicle portion may for example comprise one or more of the following components: the steering mechanism 2 (complete or partial), the steering motors 3, 4, the gearbox 5 (complete or partial), the main support 10, the upper cross member 12, the lower cross member 14, the shock suspension device 13.

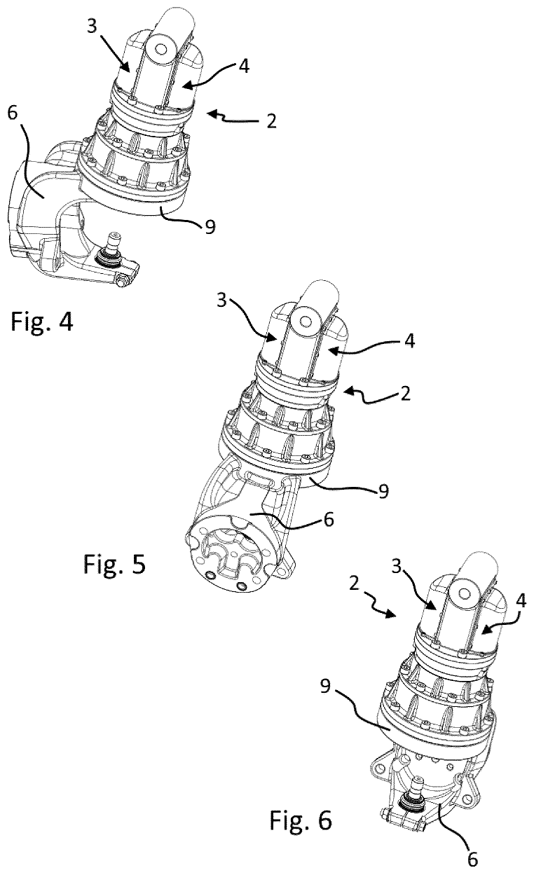

FIGS. 2 and 3 show the detailed structure of a steering mechanism 2 according to the invention in an external view (FIG. 2) and in an exploded illustration (FIG. 3), while FIGS. 4 to 6 show detailed views of a steering mechanism 2 having a connected axle stub 6 in three different rotation angles.

As can be seen in FIGS. 2 and 3, each steering motor 3, 4 is closed by its own steering motor cover 16, 17, which enables access to the individual steering motors 3, 4 for maintenance and replacement purposes, without requiring a separation of the wheel portion and the vehicle portion.

The steering motors 3, 4 can be brushless DC motors.

The steering housing furthermore comprises an upper housing 18, a center housing 19 and a lower housing 20. An upper support bearing 21 is disposed between the upper housing 18 and the center housing 19. A lower support bearing 22 is disposed between the lower housing 20 and the axle stub 6. The lower housing 20 is screwed to the lower support bearing 22 and thus closes the steering housing.

The upper housing 18 is connected to the upper cross member 12 by means of a rotary joint, e.g. with one or a plurality of screws (see also FIG. 1). The rotary joint can comprise rubber bushings or similar to prevent unwanted noise, e.g. during a suspension movement of the vehicle.

The gearbox 5 comprises a planetary gearbox 23 which is disposed so as to be coaxial with the steering axis. This design embodiment enables a compact design of the steering mechanism 2 and an uncomplicated connection of two steering motors 3, 4 to the same gearbox 5.

The two steering motors 3, 4 are assembled in the upper housing 18 and deliver a torque when activated. In normal operation, only one steering motor 3, 4 can be used to provide the torque for steering. For example, both can be used alternately (for predetermined periods of time or alternation at each vehicle start). This function can increase the efficiency of the vehicle corner module 1. The vehicle corner module 1 uses two steering motors 3, 4, inter alia for reasons of redundancy. If one steering motor 3, 4 fails, the other can take over and provide the necessary torque for the normal steering operation. In extreme situations (rough road conditions such as deep snow or mud, evading obstacles on the road), the vehicle corner module 1 can utilize both steering motors 3, 4, simultaneously to provide a higher steering torque.

The torque of the vehicle corner module 1 is transmitted to the planetary gearbox 23, which is assembled in the center housing 19 and in the bottom housing 20, by way of gears (not illustrated) which are assembled in the upper housing 18. The center housing 19 and the lower housing 20 can be designed separately or integrally.

Located on the last sun gear of the planetary gearbox 23 are torque transmission elements (not shown) which latch in the axle stub 6 and can transmit torque to steer the vehicle wheel 7 or the wheel portion. Depending on the embodiment, the last sun gear is also screwed to the axle stub 6 with one or a plurality of screws.

Between the axle stub 6 and the lower support bearing 22 there is an electromagnetic coupling which, when activated, locks the axle stub 6 to the steering mechanism 2, thus preventing a rotating movement. The electromagnetic coupling can be controlled by a local (in the vehicle corner module) or central control unit (in the vehicle) and can provide various braking stages using pulse width modulation. This is a function that can be used when the steering control is minimal (e.g. driving on the motorway) and it is not necessary to always supply a current to the steering motors 3, 4. A complete disengagement of the electromagnetic coupling is also provided, so that the steering motors 3, 4 transmit the entire torque to the wheel portion by way of the gearbox 5. The electromagnetic coupling thus improves the electrical efficiency of the vehicle corner module 1 and reduces the wear on the steering mechanism 2.

FIGS. 4 to 6 show a detailed view of a steering mechanism 2, having a connected axle stub 6 in three different rotation angles of the axle stub (and thus of the wheel portion). By comparing FIGS. 5 and 6, it can be seen that the vehicle corner module 1 permits steering angles of ±90°.

1. A vehicle corner module for individual wheel steering comprising:
a wheel portion;
a vehicle portion; and
a steering mechanism, wherein the steering mechanism comprises a steering motor and a gearbox, the steering motor being configured to rotate the wheel portion about a steering axis relative to the vehicle portion by way of the gearbox; and
wherein the steering mechanism comprises two steering motors, each of which is configured to rotate the wheel portion about the steering axis relative to the vehicle portion by way of the common gearbox.

2. The vehicle corner module as claimed in claim 1, wherein the motor axes of the steering motors are offset parallel to the steering axis.

3. The vehicle corner module as claimed in claim 1, wherein in a normal operating mode, only one of the steering motors actively rotates the wheel portion about the steering axis relative to the vehicle portion by way of the common gearbox.

4. The vehicle corner module as claimed in claim 1, wherein in a cooperation mode, the steering motors simultaneously rotate the wheel portion about the steering axis relative to the vehicle portion by way of the common gearbox.

5. The vehicle corner module as claimed in claim 1, wherein the vehicle corner module comprises a control unit which is configured to detect a failure of one of the steering motors, and in case of failure to carry out a steering actuation completely by way of the steering motor that has not failed.

6. The vehicle corner module as claimed in claim 1, wherein the gearbox comprises a planetary gearbox which is disposed coaxial with the steering axis.

7. The vehicle corner module as claimed in claim 1, wherein the wheel portion comprises an axle stub which has torque transmission elements which the gearbox engages to transfer a steering torque to the wheel portion during operation.

8. The vehicle corner module as claimed in claim 7, wherein the axle stub at an upper end comprises a steering base on which the steering mechanism sits and on which the torque transmission elements are disposed.

9. The vehicle corner module as claimed in claim 1, further comprising an electromagnetic coupling disposed between the wheel portion and the vehicle portion and configured to fix in a coupling mode the current relative rotation angle between the wheel portion and the vehicle portion.

10. The vehicle corner module as claimed in claim 1, further comprising an electromagnetic coupling disposed between the wheel portion and the vehicle portion and configured to be operated in a steering brake mode in which the electromagnetic coupling counteracts a relative rotating movement between the wheel portion and the vehicle portion with a braking torque, wherein control of the braking torque of the electromagnetic coupling in the steering brake mode is by pulse width modulation.

11. The vehicle corner module as claimed in claim 1, wherein the vehicle corner module comprises a main support comprising at least one connection geometry configured for a horizontal connection of the vehicle corner module to a vehicle, wherein no connection geometry is provided for a vertical connection between the vehicle corner module and the vehicle.

12. The vehicle corner module as claimed in claim 11, wherein at least one upper cross member is pivotably fastened to an upper end of the steering mechanism and pivotably fastened to an upper end of the main support.

13. The vehicle corner module as claimed in claim 11, wherein at least one lower cross member is connected to the axle stub below the steering base with a ball joint, wherein the lower cross member is pivotably connected to the main support.

14. The vehicle corner module as claimed in claim 13, further comprising a shock suspension device disposed between the main support and the lower cross member, wherein the shock suspension device is one of a gas spring and air spring, and wherein the lower end of the shock suspension device is pivotably fastened to the lower cross member.

15. The vehicle corner module as claimed in claim 1, wherein each steering motor is covered by its own steering motor cover which enables access to the individual steering motors without requiring a separation of the wheel portion and the vehicle portion.

16. A vehicle comprising at least one vehicle corner modules for individual wheel steering of a vehicle wheel connected to the vehicle corner module comprising:
a wheel portion;
a vehicle portion; and
a steering mechanism, wherein the steering mechanism comprises a steering motor and a gearbox, the steering motor being configured to rotate the wheel portion about a steering axis relative to the vehicle portion by way of the gearbox; and
wherein the steering mechanism comprises two steering motors, each of which is configured to rotate the wheel portion about the steering axis relative to the vehicle portion by way of the common gearbox.

17. The vehicle as claimed in claim 16, wherein the vehicle comprises a vehicle control unit which is configured to detect a high-demand mode and thereupon to instruct at least one vehicle corner module to activate a cooperation mode.

18. The vehicle as claimed in claim 17, wherein the vehicle control unit is configured to detect the high-demand mode in at least one of the following situations: poor road conditions, off-road situation, poor weather conditions, evasive maneuvers, parking maneuvers, and turning maneuvers.

19. The vehicle as claimed in claim 16, wherein the vehicle comprises a vehicle control unit which is in a steering stability mode configured to activate one of a coupling mode and a steering braking mode and to deactivate the steering motors in at least one vehicle corner module.
